(19) United States
(12) Patent Application Publication
(10) Pub. No.: US 2025/0304783 A1
(43) Pub. Date: Oct. 2, 2025

(54) Plant-Based Tar Compound

(71) Applicant: Brian Meddock, Boise, ID (US)

(72) Inventor: Brian Meddock, Boise, ID (US)

(21) Appl. No.: 19/056,862

(22) Filed: Feb. 19, 2025

Related U.S. Application Data
(60) Provisional application No. 63/572,943, filed on Apr. 2, 2024.

(51) Int. Cl. C08L 63/00; C08G 59/24; C08K 11/00

(52) U.S. Cl. CPC C08L 63/00; C08G 59/245; C08K 11/00

(57) ABSTRACT

A plant-based tar compound is provided. The device is comprised of a plant-based tar compound designed as a sustainable alternative to petroleum-based tar for various industrial applications, including construction materials, roadwork, and shingles. The compound comprises a solvent recovery byproduct obtained from plant extraction processes, which contains residual plant lipids, waxes, and fats. Polymerization of the byproduct is achieved through the addition of a polymer resin, such as diglycidyl ether of bisphenol A, and a curing agent, including amines, acid anhydrides, or polyamides, each present at concentrations of 80% or higher. The weight-to-weight ratio of these components is adjustable, ranging from 10:1:1 to 10:9:9, to modify material properties such as viscosity, elasticity, and resistance to temperature fluctuations and chemical exposure. The curing process is controlled by temperature adjustments and ratio modifications, allowing customization of the final compound's characteristics.

### CROSS-REFERENCE TO RELATED APPLICATION

The present application claims priority to, and the benefit of, U.S. Provisional Application No. 63/572,943, which was filed on Apr. 2, 2024, and is incorporated herein by reference in its entirety.

### FIELD OF THE INVENTION

The present invention relates generally to the field of tar. More specifically, the present invention relates to a plant-based tar compound formulated from a solvent recovery byproduct containing plant lipids, waxes, and fats, which undergoes polymerization through the addition of a polymer resin and a curing agent at concentrations of 80 percent or higher. The compound's properties, including viscosity, elasticity, and resistance to environmental factors, are adjustable through controlled weight-to-weight ratios, temperature modifications, and blending techniques to ensure consistency and suitability for industrial applications. Accordingly, the present disclosure makes specific reference thereto. Nonetheless, it is to be appreciated that aspects of the present invention are also equally applicable to other like applications, devices, and methods of manufacture.

### BACKGROUND

Petroleum-based tar is a byproduct of crude oil refining and is widely used in road construction, roofing materials, and industrial applications. It serves as a critical binding agent in asphalt and bitumen, providing structural integrity and weather resistance to roads and surfaces. However, its production and use present significant economic and environmental challenges. The reliance on petroleum-based tar contributes to oil dependency, increasing costs due to fluctuating crude oil prices. Additionally, the manufacturing process involves the use of harmful solvents, which pose environmental hazards, including greenhouse gas emissions and soil or water contamination. Prolonged exposure to petroleum-based tar and its associated chemicals also raises health concerns for workers handling these materials. With growing emphasis on sustainability and reducing carbon footprints, industries seek alternative materials that offer similar performance characteristics without the negative ecological impact. A viable solution would be a sustainable, bio-based tar compound that maintains the essential properties of petroleum tar while mitigating environmental and economic drawbacks.

Therefore, there exists a long-felt need in the art for a plant-based tar that provides an alternative to petroleum-based tar while maintaining comparable adhesive and structural properties. There also exists a long-felt need in the art for a plant-based tar that reduces reliance on crude oil, thereby decreasing the environmental and economic costs associated with petroleum extraction and refining. Moreover, there exists a long-felt need in the art for a plant-based tar that minimizes greenhouse gas emissions and environmental contamination, promoting more sustainable industrial practices.

The subject matter disclosed and claimed herein, in one embodiment thereof, comprises a plant-based tar compound. The device is comprised of a plant-based tar compound designed as a sustainable alternative to petroleum-based tar for various industrial applications, including construction materials, roadwork, and shingles. The compound comprises a solvent recovery byproduct obtained from plant extraction processes, which contains residual plant lipids, waxes, and fats. Polymerization of the byproduct is achieved through the addition of a polymer resin, such as diglycidyl ether of bisphenol A, and a curing agent, including amines, acid anhydrides, or polyamides, each present at concentrations of 80% or higher. The weight-to-weight ratio of these components is adjustable, ranging from 10:1:1 to 10:9:9, to modify material properties such as viscosity, elasticity, and resistance to temperature fluctuations and chemical exposure. The curing process is controlled by temperature adjustments and ratio modifications, allowing customization of the final compound's characteristics. The production method involves heating the solvent recovery byproduct until fluid, then blending the polymer resin and curing agent to achieve a homogenous mixture, ensuring consistency and suitability for its intended applications.

In this manner, the plant-based tar compound of the present invention accomplishes all the forgoing objectives and provides a bio-based alternative that functions as a direct substitute for petroleum tar in construction, roadwork, and other industrial applications. The plant-based tar compound exhibits properties similar to traditional tar, including durability, adhesion, and weather resistance. Additionally, by utilizing renewable plant-based components, this formulation significantly reduces reliance on fossil fuels and mitigates harmful environmental impacts. The controlled polymerization process allows for the customization of material properties, making it adaptable to various industrial needs while maintaining a lower carbon footprint. As a result, the plant-based tar compound offers a sustainable, economically viable, and functionally equivalent alternative to petroleum-based tar.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plant-based tar compound. The plant-based tar compound is designed for use in various applications, including shingles, construction materials, and roadwork, as a sustainable alternative to petroleum-based tar. It closely resembles conventional tar in appearance, texture, and viscosity, allowing for direct substitution in industrial applications.

The compound is comprised of a solvent recovery byproduct obtained from plant extraction processes, such as hemp or kratom extraction. This byproduct contains residual plant lipids, waxes, and fats, with its composition varying based on factors such as plant type, extraction efficiency, and solvent used.

Polymerization of the solvent recovery byproduct is achieved through the addition of a polymer resin and a curing agent. The polymer resin may include diglycidyl ether of bisphenol A (DGEBA) at concentrations of 80% or higher. The curing agent may be selected from amines, acid anhydrides, polyamides, phenalkamines, phenols, or thiols, with each used at 80% or higher concentrations. The choice of curing agent influences the compound's resistance to temperature fluctuations, chemical exposure, and mechanical stress.

The weight-to-weight ratio of the solvent recovery byproduct to the polymer resin and curing agent is adjustable, typically ranging from 10:1:1 to 10:9:9. This ratio modification allows fine-tuning of the mechanical and thermal properties to meet specific application requirements.

By way of example, the curing process is controlled by adjusting the temperature of the solvent recovery byproduct during the introduction of polymer components. Heating the mixture beyond 290° C. induces polymerization, enhancing elasticity and producing a rubber-like material. Further modifications to the compound's characteristics, such as pliability, hardness, and viscosity, can be achieved by altering component ratios and selecting different curing agents.

The manufacturing process involves heating the solvent recovery byproduct to a fluid state, then blending it with the polymer resin and curing agent until a homogenous mixture is achieved. This ensures consistent material properties, making the compound suitable for its intended industrial applications.

Accordingly, the plant-based tar compound of the present invention is particularly advantageous as it provides a bio-based alternative that functions as a direct substitute for petroleum tar in construction, roadwork, and other industrial applications. The plant-based tar compound exhibits properties similar to traditional tar, including durability, adhesion, and weather resistance. Additionally, by utilizing renewable plant-based components, this formulation significantly reduces reliance on fossil fuels and mitigates harmful environmental impacts. The controlled polymerization process allows for the customization of material properties, making it adaptable to various industrial needs while maintaining a lower carbon footprint. As a result, the plant-based tar compound offers a sustainable, economically viable, and functionally equivalent alternative to petroleum-based tar. In this manner, the plant-based tar compound overcomes the limitations of existing petroleum-based tar known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of the components of one potential embodiment of a plant-based tar compound of the present invention in accordance with the disclosed architecture;

FIG. 2 illustrates a flowchart of a method of curing in one potential embodiment of a plant-based tar compound of the present invention in accordance with the disclosed architecture; and

FIG. 3 illustrates a flowchart of a method of using one potential embodiment of a plant-based tar compound of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a plant-based tar that provides an alternative to petroleum-based tar while maintaining comparable adhesive and structural properties. There also exists a long-felt need in the art for a plant-based tar that reduces reliance on crude oil, thereby decreasing the environmental and economic costs associated with petroleum extraction and refining. Moreover, there exists a long-felt need in the art for a plant-based tar that minimizes greenhouse gas emissions and environmental contamination, promoting more sustainable industrial practices.

The present invention, in one exemplary embodiment, is comprised of a plant-based tar compound that serves as a sustainable alternative to petroleum-based tar for applications such as shingles, construction materials, and roadwork. The compound maintains a similar appearance, texture, and viscosity to conventional tar, enabling direct substitution in industrial use.

The compound is comprised of a solvent recovery byproduct derived from plant extraction processes, including hemp or kratom extraction. This byproduct contains residual plant lipids, waxes, and fats, with its composition influenced by factors such as plant type, extraction efficiency, and the solvent used.

Polymerization of the solvent recovery byproduct is achieved through the addition of a polymer resin and a curing agent. The polymer resin may include diglycidyl ether of bisphenol A (DGEBA) at concentrations of 80% or higher. The curing agent may be selected from amines, acid anhydrides, polyamides, phenalkamines, phenols, or thiols, each used at 80% or higher concentrations. The choice of curing agent affects resistance to temperature fluctuations, chemical exposure, and mechanical stress.

The weight-to-weight ratio of the solvent recovery byproduct to the polymer resin and curing agent is adjustable, typically ranging from 10:1:1 to 10:9:9. This ratio modification allows for fine-tuning of mechanical and thermal properties to meet specific application needs.

The curing process is controlled by adjusting the temperature of the solvent recovery byproduct during polymer component introduction. Heating the mixture beyond 290° C. induces polymerization, enhancing elasticity and producing a rubber-like material. Further modifications to pliability, hardness, and viscosity can be achieved by adjusting component ratios and selecting different curing agents.

The manufacturing process involves heating the solvent recovery byproduct to a fluid state, followed by blending it with the polymer resin and curing agent until a homogeneous mixture is achieved. This ensures consistency in material properties for industrial applications.

The plant-based tar compound offers a bio-based alternative that functions as a direct replacement for petroleum tar in construction, roadwork, and other industrial applications. It exhibits durability, adhesion, and weather resistance comparable to traditional tar. By utilizing renewable plant-based components, this formulation reduces dependence on fossil fuels and mitigates environmental impact. The controlled polymerization process allows for the customization of material properties, making it adaptable to industrial requirements while maintaining a lower carbon footprint. As a result, the plant-based tar compound provides a sustainable, economically viable, and functionally equivalent alternative to petroleum-based tar, addressing the limitations of conventional tar formulations.

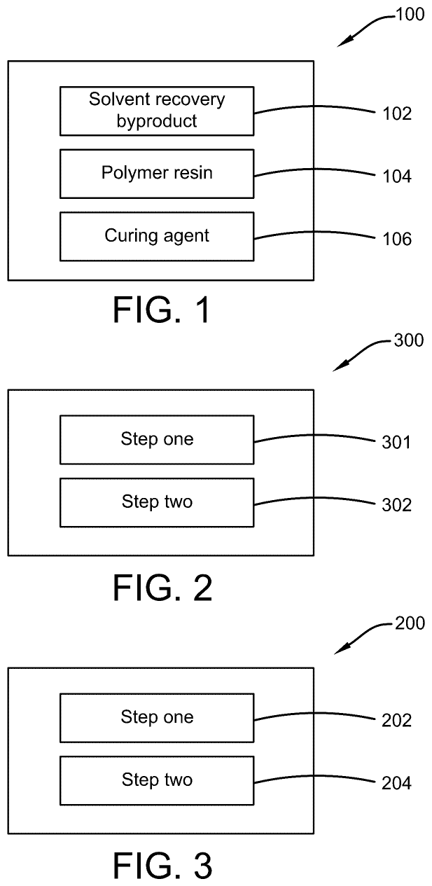

Referring initially to the drawings, FIG. 1 illustrates a graphical view of components of one potential embodiment of a plant-based tar compound 100 of the present invention in accordance with the disclosed architecture. The plant-based tar compound 100 is provided for use in various tar-related applications, including but not limited to plant-based shingles, construction materials, roadwork, and other industries that traditionally rely on petroleum-based tars. The plant-based tar compound 100 closely resembles petroleum-based tar in terms of appearance, texture, and viscosity while exhibiting similar physical properties. Due to these characteristics, the plant-based tar compound 100 serves as a direct substitute in applications where conventional tar is commonly used. By offering a sustainable alternative, the plant-based tar compound 100 provides an environmentally friendly option suitable for a wide range of industrial uses.

The plant-based tar compound 100 is comprised of a solvent recovery byproduct 102 obtained after plant extraction processes such as hemp extraction, kratom extraction, or similar procedures. The solvent recovery byproduct 102 is comprised of residual plant lipids, waxes, and fats. The specific concentration of these components varies based on multiple factors, including the type of plant being processed, the efficiency of the solvent recovery process, and the nature of the solvent used during extraction. These variables influence the composition of the byproduct 102 and, consequently, the properties of the final plant-based tar compound 100.

The polymerization of the solvent recovery byproduct 102 is achieved through the addition of a polymer resin 104 and a curing agent 106. The polymer resin 104 may include, but is not limited to, diglycidyl ether of bisphenol A (DGEBA), which is present in a concentration of 80% or higher. The curing agent 106 may be selected from amines, acid anhydrides, polyamides, phenalkamines, phenols, or thiols, including combinations thereof. Each curing agent 106 is used in a concentration of 80% or higher. The selection of a specific curing agent 106 influences the final properties of the plant-based tar compound 100, including resistance to temperature fluctuations, chemical exposure, and mechanical stress.

The weight-to-weight ratio of the solvent recovery byproduct 102 to the polymer components 104 and 106 can be adjusted to modify the material characteristics of the final compound 100. By way of example, the ratio of solvent recovery byproduct 102 to polymer resin 104 to curing agent 106 may range from 10:1:1 to 10:9:9, with the potential for higher ratios depending on the desired properties of the final compound 100. Adjusting these proportions allows for fine-tuning of the mechanical and thermal properties of the plant-based tar compound 100 to meet specific application requirements.

The curing process of the plant-based tar compound 100 is controlled through multiple factors that influence the final properties of the material. One primary method of curing 300, as seen in FIG. 2., involves adjusting the temperature of the solvent recovery byproduct 102 during the introduction of the polymer components 104 and 106 [Step 302]. The temperature at which the polymer resin 104 and curing agent 106 are mixed with the byproduct 102 affects the pliability of the final compound 100 once cooled. Additionally, heating the mixture to temperatures exceeding 290° C. induces polymerization in a manner that enhances elasticity, resulting in a rubber-like material. Further modifications to the final properties of the compound 100 can be achieved by altering the ratios of solvent recovery byproduct 102, polymer resin 104, and curing agent 106 [Step 301]. These ratio adjustments influence characteristics such as pliability, hardness, and viscosity, allowing for customization of the compound's 100 structural and mechanical attributes. Additionally, selecting different types of curing agents 106 provides further control over temperature resistance, chemical resistance, flexibility, and curing time.

A method of making 200 the plant-based tar compound 100 (as seen in FIG. 3) begins with heating the solvent recovery byproduct 102 until it reaches a fluid state [Step 202]. Once the byproduct 102 is sufficiently liquefied, the polymerization agents 104 and 106 are introduced and blended until a homogenous mixture is achieved [Step 204]. This uniform distribution of the polymer resin 104 and curing agent 106 ensures that the final compound 100 possesses consistent properties throughout, making it suitable for its intended applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plant-based tar compound” and “compound” are interchangeable and refer to the plant-based tar compound 100 of the present invention.

Notwithstanding the forgoing, the plant-based tar compound 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plant-based tar compound 100 as shown in the FIGS. are for illustrative purposes only, and that many other sizes and shapes of the plant-based tar compound 100 are well within the scope of the present disclosure. Although the dimensions of the plant-based tar compound 100 are important design parameters for user convenience, the plant-based tar compound 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant-based tar compound comprising:
a solvent recovery byproduct;
a polymer resin comprising diglycidyl ether of bisphenol A; and
a curing agent.

2. The plant-based tar compound of claim 1, wherein the solvent recovery byproduct is comprised of a plant lipid.

3. The plant-based tar compound of claim 1, wherein the solvent recovery byproduct is comprised of a plant wax.

4. The plant-based tar compound of claim 1, wherein the solvent recovery byproduct is comprised of a plant fat.

5. The plant-based tar compound of claim 1, wherein the diglycidyl ether of bisphenol A is present in a concentration of 80 percent or higher.

6. The plant-based tar compound of claim 1, wherein the curing agent is comprised of an amines, an acid anhydrides, a polyamides, a phenalkamine, a phenol, a thiol, or a combinations thereof.

7. The plant-based tar compound of claim 1, wherein the curing agent is present in a concentration of 80 percent or higher.

8. A plant-based tar compound comprising:
a solvent recovery byproduct obtained from a hemp extraction or a kratom extraction;
a polymer resin comprising diglycidyl ether of bisphenol A; and
a curing agent.

9. The plant-based tar compound of claim 8, wherein the solvent recovery byproduct is comprised of a plant lipid.

10. The plant-based tar compound of claim 8, wherein the solvent recovery byproduct is comprised of a plant wax.

11. The plant-based tar compound of claim 8, wherein the solvent recovery byproduct is comprised of a plant fat.

12. The plant-based tar compound of claim 8, wherein the diglycidyl ether of bisphenol A is present in a concentration of 80 percent or higher.

13. The plant-based tar compound of claim 8, wherein the curing agent is comprised of an amines, an acid anhydrides, a polyamides, a phenalkamine, a phenol, a thiol, or a combinations thereof.

14. The plant-based tar compound of claim 8, wherein the curing agent is present in a concentration of 80 percent or higher.

15. A method of using a plant-based tar compound, the method comprising:
heating a solvent recovery byproduct until the solvent recovery byproduct reaches a fluid state; and
blending a polymer resin and a curing agent with the solvent recovery byproduct to form a homogenous mixture.

16. The method of using a plant-based tar compound of claim 15, wherein the curing agent is comprised of an amines, an acid anhydrides, a polyamides, a phenalkamine, a phenol, a thiol, or a combinations thereof.

17. The method of using a plant-based tar compound of claim 15, wherein the solvent recovery byproduct is comprised of a plant lipid, a plant wax, a plant fat, or a combination thereof.

18. The method of using a plant-based tar compound of claim 15, wherein the polymer resin is present in a concentration of 80 percent or higher.

19. The method of using a plant-based tar compound of claim 15, wherein the curing agent is present in a concentration of 80 percent or higher.

20. The method of using a plant-based tar compound of claim 15, wherein the polymer resin is comprised of a diglycidyl ether of bisphenol A.
